(19) United States
(12) Patent Application Publication
(10) Pub. No.: US 2018/0282469 A1
(43) Pub. Date: Oct. 4, 2018

(54) RIGID POLYURETHANE FOAM COMPRISING POLYESTER POLYETHER POLYOL

(71) Applicant: Dow Global Technologies LLC, Midland, MI (US)

(72) Inventors: Paolo GOLINI, Corregio (IT); Cecilia GIROTTI, Corregio (IT)

(73) Assignee: Dow Global Technologies LLC, Midland, MI (US)

(21) Appl. No.: 15/764,137

(22) PCT Filed: Sep. 19, 2016
(86) PCT No.: PCT/US2016/052478

§ 371 Date: Mar. 28, 2018

(30) Foreign Application Priority Data
Sep. 29, 2015 (IT) 102015000056432

(51) Int. Cl. C08G 18/48; C08G 18/76; C08J 9/14

(52) U.S. Cl. CPC C08G 18/4854; C08G 18/7671; C08J 2203/162; C08G 18/4816; C08J 2375/04; C08J 9/146

(57) ABSTRACT

Polyurethane foams are provided. The polyurethane foams are produced from a formulation that includes an isocyanate reacting mixture, an isocyanate component, and a blowing agent. The isocyanate reacting mixture includes at least 40 wt % of at least one propoxylated polyester-polyether polyol based on the total weight of the isocyanate reacting mixture. The isocyanate reacting mixture also includes at least one of propoxylated sucrose polyol or propoxylated sorbitol polyol. The propoxylated sucrose polyol and/or propoxylated sorbitol polyol has a hydroxyl number of from about 300 mg KOH/g to about 600 mg KOH/g. The polyurethane foam has a compressive strength of at least 130 kPa, and a stoichiometric index of the isocyanate component to the isocyanate reacting mixture is between about 1.0 and 1.7.

### CROSS-REFERENCE TO RELATED APPLICATIONS

This application claims priority to Italian Patent Application No. 102015000056432, filed Sep. 29, 2015, the contents of which is hereby incorporated by reference in its entirety.

### TECHNICAL FIELD

Embodiments of the present disclosure are generally related to rigid polyurethane foams, and are specifically related to rigid polyurethane foams prepared from polyester polyether polyols.

### BACKGROUND

Rigid polyurethane foams are widely used as insulating materials, for example, in construction and appliance industries. Typically, these foams are closed-cell, rigid foams that contain a low-conductivity gas, such as a hydrocarbon, within the cells. The foaming compositions may be poured in liquid form in order to form rigid foam boards or panels using a continuous or discontinuous process. The panels may further include a facing, such as a metal foil, that is adhered to the foam.

Unfortunately, as lower densities are desired by consumers, the rigid polyurethane foams may sacrifice mechanical properties, such as compressive strength, thermal insulation, or durability. Accordingly, there is a need for polyurethane foam compositions that provide a desired level of compressive strength and thermal insulation while maintaining good flowability and a low fill density.

### SUMMARY

Embodiments are directed to rigid polyurethane foam compositions produced from the reaction of isocyanates and isocyanate reacting mixtures comprising propoxylated polyester-polyether polyol in addition to at least one of a propoxylated sucrose polyol or a propoxylated sorbitol polyol. The rigid polyurethane foams may have improved compressive strength, for example, a compressive strength of at least 130 kPa. The polyurethane foams may also demonstrate improved tensile bond strengths, excellent thermal insulation properties, and a flowability and fill density suitable for various applications.

According to one embodiment, a polyurethane foam is provided. The polyurethane foam is produced from a formulation that includes an isocyanate reacting mixture, an isocyanate component having an average functionality of at least 2.5, and a blowing agent. The isocyanate reacting mixture includes at least 40 wt % of at least one propoxylated polyester-polyether polyol. The isocyanate reacting mixture also includes at least one of propoxylated sucrose polyol or propoxylated sorbitol polyol. The propoxylated sucrose polyol and/or propoxylated sorbitol polyol has a hydroxyl number of from about 300 mg KOH/g to about 600 mg KOH/g. The polyurethane foam has a compressive strength of at least 130 kPa, and a stoichiometric index of the isocyanate component to the isocyanate reacting mixture is between about 1.0 and 1.7.

### DETAILED DESCRIPTION

In various embodiments, a formulation for producing rigid polyurethane foam is provided. In general, the formulation includes an isocyanate component, an isocyanate reacting mixture including polyols that react with the isocyanate component, and a blowing agent. According to various embodiments, the isocyanate reacting mixture includes at least 40 wt % of at least one propoxylated polyester-polyether polyol and at least one of propoxylated sucrose polyol or propoxylated sorbitol polyol. The resultant polyurethane foam has a compressive strength of at least 130 kPa, and a stoichiometric index of the isocyanate component to the isocyanate reacting mixture is between about 1.0 and 1.7. Without being bound by theory, these formulations have been found to produce rigid polyurethane foams having superior thermal insulation performance along with fast demolding, improved flowability, and improved compressive strength and tensile bond strength.

In further embodiments, the isocyanate reacting mixture may include from 40 wt % to about 90 wt % of the propoxylated polyester-polyether polyol, or from 40 wt % to about 75 wt % of the propoxylated polyester-polyether polyol, or from 40 wt % to about 60 wt % of the propoxylated polyester-polyether polyol, or from about 45 wt % to about 60 wt % of the propoxylated polyester-polyether polyol, or from 45 wt % to about 55 wt % of the propoxylated polyester-polyether polyol.

Various molecular weights are contemplated for the propoxylated polyester-polyether polyol. For example, the propoxylated polyester-polyether polyol may have a number average molecular weight of from about 200 g/mol to about 500 g/mol. In some embodiments, the molecular weight is greater than about 200 g/mol. In some embodiments, the molecular weight may be less than about 400 g/mol or less than about 300 g/mol. Accordingly, in some embodiments, the molecular weight of the propoxylated polyester-polyether polyol has a molecular weight of from about 200 g/mol to about 300 g/mol. Examples of suitable propoxylated polyester-polyether polyols, including suitable molecular weights, are described more fully in U.S. Publication No. 2014/213677, the entirety of which is hereby incorporated by reference.

Compositionally, the propoxylated polyester-polyether polyol, sometimes called a polyester-polyether polyol, is a hybrid structure of the polyester polyol and polyether polyol, not a mixture of polyester polyols and polyether polyols. Generally, the propoxylated polyester-polyether polyol is produced from at least one carboxyl containing ester precursor (e.g., phthalic anhydride), at least one polyol, at least one epoxide, and at least one polymerization catalyst.

The polyols used for the propoxylated polyester-polyether polyol may include various polyhydroxyl compounds. In one or more embodiments, the polyols may comprise branched aliphatic alcohols. Examples of suitable branched aliphatic alcohols may include three or more hydroxyl groups such as trihydroxy alcohols, including but not limited to glycerin and trimethylol propane. The carboxyl containing ester precursor may include various carboxyl containing compounds, for example, dicarboxylic acid based compounds. These dicarboxylic acid based compounds may include aromatic dicarboxylic acid compositions, such as phthalic anhydride.

While propylene oxides are generally used as the epoxide for formation of the polyether-polyether polyol, various additional epoxides are contemplated. For example and not by way of limitation, these alternative epoxides may comprise C₂ to C₄ epoxides, ethylene oxide, 1,2- or 2,3-butylene oxide, tetramethylene oxide, or a combination thereof. Examples of alternative epoxides are described more fully in U.S. Publication No. 2014/213677, the entirety of which is hereby incorporated by reference.

Moreover, these alternative epoxides may be used in combination with the propylene oxides. In one or more embodiments, the polyether polyol will contain greater than 70% by weight of epoxide units derived from propylene oxide (PO) units. In some embodiments, the polyether polyol will contain greater than about 75% by weight of epoxide units derived from PO units, greater than about 80% by weight of epoxide units derived from PO units, or greater than about 85% by weight of epoxide units derived from PO units. In still other embodiments, the polyether polyol contains 100% by weight of epoxide units derived from PO units. When an epoxide other than PO is used, it may be co-fed with PO.

Catalysis for the polymerization of epoxides may involve anionic polymerization (through the use of alkaline catalysts, such as potassium hydroxide) or cationic polymerization (through the use of Lewis acid catalysts, such as boron trifluoride). For example and not by way of limitation, suitable polymerization catalysts may include potassium hydroxide, cesium hydroxide, boron trifluoride, or a double cyanide complex (DMC) catalyst such as zinc hexacyanocobaltate or quaternary phosphazenium compound. In anionic polymerization embodiments, the alkaline catalyst may be removed from the polyether polyol at the end of production by a finishing step, such as coalescence, magnesium silicate separation, or acid neutralization.

Polyether polyols are generally produced by the alkoxylation of polyols (also called initiators) by an epoxide in the presence of polymerization catalyst. Polyester polyols are generally produced from the reaction of a polyol with a carboxyl containing ester precursor followed by alkoxylation by an epoxide. To produce the hybrid compositional structure of the propoxylated polyester-polyether polyol, it is contemplated that these reaction methodologies may be merged in various ways. For example, it is contemplated that the carboxyl containing ester precursor, at least one polyol, at least one epoxide, and at least one polymerization catalyst may be added to a reactor such that the polymerization/alkoxylation reactions used to produce the propoxylated polyester-polyether polyol occur simultaneously. Alternatively, the propoxylated polyester-polyether polyol may be produced through a stepwise procedure.

In one embodiment, the polyether polyol may be produced in a first polymerization step. Then, the produced polyether polyol reacts with the carboxyl containing ester precursor (e.g., phthalic anhydride) to produce a half-ester, which is defined as a carboxyl containing polyether polyol prior to alkoxylation with an epoxide. Next, the half-ester is alkoxylated in a second polymerization step to form the propoxylated polyester-polyether polyol.

In an exemplary embodiment, the propoxylated polyester-polyether polyol is produced from alkoxylating a half-ester produced by reacting phthalic anhydride and a propoxylated glycerin polyol. In one or more embodiments, the propoxylated glycerin polyol may have a molecular weight of about 200 g/mol to about 300 g/mol, or about 250 g/mol. In addition, prior to reacting the propoxylated glycerin with the phthalic anhydride, the propoxylated glycerin may be added to a reactor and stripped to remove residual water. The phthalic anhydride is then added to the propoxylated glycerin to form the half-ester. The half-ester is then alkoxylated to form the polyester-polyether polyol, such as by addition of an epoxide to the reactor after formation of the half-ester. The polymerization of propoxylated glycerin with phthalic anhydride may be performed autocatalytically due to the presence of acid groups in the half-ester, or may be aided by catalysts such as a double cyanide complex (DMC) catalyst. DMC catalysts may include, by way of example and not limitation, zinc hexacyanocobaltate, quaternary phosphazenium compound, amine catalysts, or superacid catalysts.

To minimize transesterification between the phthalic anhydride and the propoxylated glycerin, in various embodiments, the formation of the propoxylated polyester-polyether polyol may take place at a temperature of from about 80° C. to about 150° C. In some embodiments, the reaction has a temperature of from about 90° C. to about 140° C. or even from about 100° C. to about 135° C. In various embodiments, the reaction is conducted at a pressure of from about 30 kPa to about 600 kPa. In some embodiments, the reaction is conducted at a pressure of from about 100 kPa to about 400 kPa. The reaction time may be from about 1 hour to about 24 hours. In some embodiments, the reaction time may be from about 2 hours to about 12 hours, or even from about 2 hours to about 6 hours.

Optionally, a PO digestion step is also contemplated, for example, in the presence of dimethylethanolamine (DMEA). Vacuum stripping may also be used in specific embodiments used to remove any unreacted epoxide component (unreacted PO, for example) and/or other volatiles.

In various embodiments, the amount of epoxide added to the half-ester is sufficient to produce a propoxylated polyester-polyether polyol having a hydroxyl number of from about 200 mg KOH/g to about 350 mg KOH/g. As used herein, a hydroxyl number is the milligrams of potassium hydroxide equivalent to the hydroxyl content in one gram of the polyol or other hydroxyl compound. In some embodiments, the resultant polyester-polyether has a hydroxyl number of from about 220 mg KOH/g to about 330 mg KOH/g. In still other embodiments, the resultant polyester-polyether has a hydroxyl number of from about 280 mg KOH/g to about 330 mg KOH/g. In other embodiments, the polyester-polyether has a hydroxyl number of at least 300 mg KOH/g. The polyester-polyether may have an average functionality of from about 2.7 to about 4.5, or from about 3.5 to about 4.5. As used herein, the average functionality is the number of isocyanate reactive sites on a molecule, and may be calculated as the total number of moles of OH over the total number of moles of polyol. In some embodiments, the polyester-polyether has an average functionality of about 3.

The viscosity of the resulting polyester-polyether polyol is generally less than 40,000 mPa*s at 25° C. as measured by ASTM D4878. In some embodiments, the viscosity is between 20,000 mPa*s and 40,000 mPa*s.

In various embodiments, the isocyanate reacting mixture further includes at least one of a propoxylated sucrose polyol or a propoxylated sorbitol polyol, sometimes referred to herein as propoxylated sucrose-initiated polyols or propoxylated sorbitol-initiated polyols, respectively. In further embodiments, it is contemplated that other polyols such as glycerin initiated polyols may be included with the sucrose and/or sorbitol polyols. In various embodiments, the propoxylated sucrose polyol, the propoxylated sorbitol polyol, or a mixture thereof, comprises polyether polyols having a number average molecular weight of from about 200 g/mol and 1,500 g/mol, an average functionality of at least 4 and a hydroxyl number of at least 150 mg KOH/g.

In further embodiments, the number average molecular weight may be from about 450 g/mol to about 900 g/mol. Moreover, the average functionality may be from about 4 to about 5, or about 4 to about 4.5. In additional embodiments, the propoxylated sucrose polyol and/or propoxylated sorbitol polyol may have a hydroxyl number of from about 300 mg KOH/g to about 600 mg KOH/g, or a hydroxyl number of at least 350 mg KOH/g, or a hydroxyl number of between about 450 mg KOH/g to about 500 mg KOH/g. Examples of suitable propoxylated sucrose or sorbitol polyols are described more fully in U.S. Pat. No. 4,394,491, the entirety of which is hereby incorporated by reference. In various embodiments, suitable propoxylated sucrose polyols include those commercially available under the trademark VORANOL™, such as VORANOL™ RN-490 (sucrose-glycerin initiated polyol, having a hydroxyl number of 490 mg KOH/g and an average functionality of 4.3), available from The Dow Chemical Company (Midland, Mich.). Suitable propoxylated sorbitol polyols may include those commercially available under the trademark TERCAROL™, such as TERCAROL™ 8092 (sorbitol initiated polyol, having a hydroxyl number of 460 mg KOH/g and an average functionality of 5), also available from The Dow Chemical Company (Midland, Mich.).

In various embodiments, the isocyanate reacting mixture may include at least about 20 wt %, at least about 30 wt %, at least about 40 wt %, or at least about 50 wt % of the at least one of propoxylated sucrose polyol or propoxylated sorbitol polyol. Moreover, the isocyanate reacting mixture may include from about 20 wt % to 60 wt % of the propoxylated sucrose polyol or propoxylated sorbitol polyol, or at least about 30 wt % to about 50 wt % of the propoxylated sucrose polyol or propoxylated sorbitol polyol, at least about 35 wt % to about 50 wt % of propoxylated sucrose polyol or propoxylated sorbitol polyol.

Additional polyether polyols may also be included in the isocyanate reacting mixture of some embodiments. For example, in a specific embodiment, the isocyanate reacting mixture also includes a propoxylated glycerin polyol. In this embodiment, the propoxylated glycerin polyol is a polyether polyol having a hydroxyl value of at least 50 mg KOH/g and an average functionality of 3. In further embodiments, the hydroxyl value may be at least 100 mg KOH/g, at least 150 mg KOH/g, from about 50 mg KOH/g to about 500 mg KOH/g, from about 100 mg KOH/g to about 400 KOH/g, or from about 150 mg KOH/g to about 350 mg KOH/g. Suitable propoxylated glycerin polyols include those commercially available as VORANOL™ CP 1055, available from The Dow Chemical Company (Midland, Mich.). The isocyanate reacting mixture may include from about 1 wt % to about 20 wt %, from about 2 wt % to about 15 wt %, or from about 5 wt % to about 12 wt % of the propoxylated glycerin polyol.

Various compositions are considered suitable for the isocyanate component. The isocyanate component, in various embodiments, has an average functionality of at least about 2.5 or from about 2.5 to about 3.2. In some embodiments, the isocyanate component may include one or more diisocyanates. For example, in some embodiments the isocyanate component may include aromatic diisocyanates, such as methylene diphenyl diisocyanate (MDI) or polymeric diphenylmethane diisocyanate (PMDI) having an average functionality of at least 2.7 or from about 2.7 to about 3.2. A commercially suitable embodiment may include VORANATE™ M220, which is available from The Dow Chemical Company (Midland, Mich.).

The amount of isocyanate may vary based on application and is disclosed herein by the stoichiometric index. As stated above, the stoichiometric index of the isocyanate component to the isocyanate reacting mixture is between about 1.0 and 1.7. In further embodiments, the stoichiometric index is between 1.1 to 1.5, or 1.2. to 1.4.

In various embodiments, the isocyanate component has an equivalent weight between 125 g/mol and 175 g/mol, or an equivalent weight between 130 g/mol and 140 g/mol. As used herein, the equivalent weight is the weight of a compound per reactive site and is calculated according to the following equation:

$$Equivalent Weight = \frac{56.1 \times 1000}{OH number + acid number}$$

The isocyanate component may have a viscosity of from about 0.1 Pa*s to about 1.5 Pa*s in various embodiments, although in some embodiments, the viscosity of the isocyanate component is from about 0.2 Pa*s to about 0.7 Pa*s at 25° C.

In various embodiments, the blowing agent may be selected based at least in part on the desired density of the final foam. The blowing agent may be added to the isocyanate reacting mixture before the isocyanate reacting mixture is combined with the isocyanate component. Without being bound by theory, the blowing agent may absorb heat from the exothermic reaction of the combination of the isocyanate component with the isocyanate reacting mixture and vaporize and provide additional gas useful in expanding the polyurethane foam to a lower density. In various embodiments, the blowing agent is a hydrocarbon. In some embodiments, hydrocarbon or fluorine-containing hydrohalocarbon blowing agents may be employed. The hydrocarbon may be, for example, a hydrofluoroolefin carbon. The blowing agent may comprise, by way of example and not limitation, butane, isobutane, 2,3-dimethylbutane, n- and i-pentane isomers, hexane isomers, heptane isomers, cycloalkanes including cyclopentane (c-pentane), cyclohexane, cycloheptane, and combinations thereof, HFC-245fa (1,1,1,3,3-pentafluoropropane, HFC-365mfc (1,1,1,3,3-penta-flurobutane), HFC-227ea (1,1,1,2,3,3,3-heptafluropropane), HFC-134a (1,1,1,2-tetrafluroethane), combinations thereof, and the like. In one embodiment, the blowing agent comprises c-pentane. Examples of suitable blowing agents include those sold by Honeywell under the name Solstice® and those sold by Arkema under the name Forane®. In various embodiments, the total amount of blowing agent is at least about 3 wt % of the polyurethane formulation, or about 3 wt % to about 20 wt % of the polyurethane formulation, or about 3 wt % to about 8 wt % of the polyurethane formulation.

The formulation may further include additives or other modifiers that are known in the art. For example, surfactants, flame retardants, and catalysts may be employed. Catalysts may include, by way of example and not limitation, trimerization catalysts, and tertiary amine catalysts. Dispersing agents, cell stabilizers, and surfactants may also be incorporated into the formulations.

Trimerization catalysts may be any trimerization catalyst known in the art that will catalyze the trimerization of an organic isocyanate compound. Trimerization of isocyanates may yield polyisocyanurate compounds inside the polyurethane foam. Without being limited to theory, the polyisocyanurate compounds may make the polyurethane foam more rigid and provide improved reaction to fire. Trimerization catalysts can include, for example, glycine salts, tertiary amine trimerization catalysts, alkali metal carboxylic acid salts, and mixtures thereof. In some embodiments, sodium N-2-hydroxy-5-nonylphenyl-methyl-N-methylglycinate may be employed. When used, the trimerization catalyst may be present in an amount less than 1 wt % of the formulation used to produce the polyurethane foam.

Tertiary amine catalysts include organic compounds that contain at least one tertiary nitrogen atom and are capable of catalyzing the hydroxyl/isocyanate reaction between the isocyanate component and the isocyanate reacting mixture. Tertiary amine catalysts can include, by way of example and not limitation, triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N,N′,N″-tris(dimethylamino-propyl)sym-hexahydrotriazine, and mixtures thereof. In further embodiments, the amine catalyst includes bis(2-dimethylamino-ethyl)ether, dimethylcyclohexylamine, N,N-dimethyl-ethanolamine, triethylenediamine, triethylamine, 2,4,6-tri(dimethylaminomethyl)phenol, N,N′,N-ethylmorpholine, and/or mixtures thereof. When used, the tertiary amine catalyst may be present in an amount less than 1 wt % of the formulation used to produce the polyurethane foam.

In various embodiments, fire performance may be enhanced by including one or more flame retardants. Flame retardants may be brominated or non-brominated and may include, by way of example and not limitation, tris(1,3-dichloropropyl)phosphate, tris(2-choroethyl)phosphate, tris(2-chloropropyl)phosphate, diammonium phosphate, various halogenated aromatic compounds, antimony oxide, alumina trihydrate, and combinations thereof. When used, the flame retardant may be present in an amount from 0.1 wt % to about 10 wt % of the formulation used to produce the polyurethane foam, or about 0.5 wt % to about 5 wt % of the formulation used to produce the polyurethane foam.

Surfactants, including organic surfactants and silicone-based surfactants, may be added to serve as cell stabilizers. As used herein, “cell stabilizers” are compounds employed to stabilize the foaming reaction mixture against collapse and the formation of large uneven cells until it cures. Various compositions are contemplated for the surfactants. In one embodiment, the surfactant is an organosilicone surfactant. Examples of suitable organosilicones include those sold by Evonik under the Tegostab™ name, for example, Tegostab B8496. When used, the surfactant may be present in an amount less than 1 wt % of the formulation used to produce the polyurethane foam.

In various embodiments, the polyurethane polymer is prepared by mixing the reaction components, including the isocyanate reacting mixture, the isocyanate component, and the blowing agent at room temperature or at a temperature slightly above room temperature for a short period of time (e.g., less than about 10 seconds or less than about 1 second). In some embodiments, the isocyanate reacting mixture and the blowing agent may be mixed prior to or upon addition to the isocyanate component. Other additives, including catalysts, flame retardants, and surfactants, may be added to the isocyanate reacting mixture prior to addition of the blowing agent. Mixing may be performed in a spray apparatus, a mix head, or a vessel. Following mixing, the mixture may be sprayed or otherwise deposited onto a substrate or into an open mold. Alternatively, the mixture may be injected inside a cavity, in the shape of a panel or otherwise. This cavity may be optionally kept at atmospheric pressure or partially evacuated to sub-atmospheric pressure (i.e., up to about −50 kPa).

Upon reacting, the mixture takes the shape of the mold or adheres to the substrate to produce a polyurethane polymer which is then allowed to cure, either partially or fully. Suitable conditions for promoting the curing of the polyurethane polymer include a temperature of from about 20° C. to about 150° C. In some embodiments, the curing is performed at a temperature of from about 35° C. to about 75° C. In other embodiments, the curing is performed at a temperature of from about 45° C. to about 55° C. In various embodiments, the temperature selected for curing may be selected at least in part based on the amount of time required for the polyurethane polymer to gel and/or cure at that temperature. Cure time will also depend on other factors, including, for example, the particular components (e.g., catalysts and quantities thereof), and the size and shape of the article being manufactured.

The polyurethane foam of the present embodiments include a compressive strength of at least 130 kPa, and a tensile bond strength of at least 130 kPa which makes it suitable for a rigid foam. Some embodiments exhibit a compressive strength of at least 135 kPa and/or a tensile bond strength of at least 135 kPa. Further embodiments exhibit a compressive strength of from about 130 kPa to about 160 kPa or from about 135 kPa to about 145 kPa and/or a tensile bond strength of from about 135 kPa to about 250 kPa or from about 135 kPa to about 155 kPa. Additionally, as described further in the examples below, the formulation that is used to produce the foam has a minimum fill density of less than about 40 g/L, and a gel time of at greater than about 120 s at 20-22° C. The formulation may produce a foam having a minimum fill density of from about 16 g/L to about 40 g/L, from about 25 g/L to about 40 g/L or from about 35 g/L to about 40 g/L. The gel time may be from about 120 s to about 250 s at 20-22° C., from about 125 s to about 160 s at 20-22° C., or from about 130 s to about 145 s at 20-22° C.

### EXAMPLES

The following examples are provided to illustrate various embodiments, but are not intended to limit the scope of the claims. All parts and percentages are by weight unless otherwise indicated.

A description of the raw materials used in the examples is as follows:

TERCAROL™ 8092 is a sorbitol-initiated polyether polyol, with a hydroxyl value of 460 mg KOH/g and an average functionality of 5, available from The Dow Chemical Company (Midland, Mich.);

VORANOL™ RN490 is a reaction mass of sucrose propoxylated and glycerin propoxylated, with a hydroxyl value of 490 mg KOH/g and an average functionality of 4.3, available from The Dow Chemical Company (Midland, Mich.);

Aromatic polyester polyol #1 is an aromatic polyester polyol from terephthalic acid, polyglycols and glycerin, with a hydroxyl value of 315 mg KOH/g and an average functionality of 2.4, available from The Dow Chemical Company (Midland, Mich.);

TERCAROL™ 5902 is an O-toluene diamine initiated polyether polyol, with a hydroxyl value of 380 mg KOH/g and an average functionality of 4, available from The Dow Chemical Company (Midland, Mich.);

Stepanpol PS 3152 is an aromatic polyester polyol, with a hydroxyl value of 315 mg KOH/g and an average functionality of 2.0, available from Stepan Company;

VORANOL™ CP 1055 is a glycerine-initiated polyether polyol, with a hydroxyl value of 165 mg KOH/g and an average functionality of 3, available from The Dow Chemical Company (Midland, Mich.);

TCPP is tris-(chloroisopropyl)phosphate, a flame retardant available from Quimidroga S.A;

PMDETA is pentamethyldiethylene triamine, a catalyst available from Air Products and Chemicals, Inc.;

DMCHA is N,N-dimethylcyclohexylamine, a catalyst available from Air Products and Chemicals, Inc.;

TEGOSTAB® B 8496 is a silicone surfactant available from Evonik Industries;

c-pentane is cyclopentane, a blowing agent, available from Sigma-Aldrich; and

VORANATE™ M220 is a polymeric methylene-diphenyl-diisocyanate, having an average functionality of 2.7, available from The Dow Chemical Company (Midland, Mich.).

Table 1 below lists Comparative Examples 1-3, which include various polyols but exclude propoxylated polyester-polyether polyol, and Examples 1 and 2, which are two exemplary embodiments of the present formulations. All numbers are represented in parts by weight of the total weight of the composition.

Propoxylated polyester-polyether polyol #1, included in Examples 1 and 2, was produced by adding 41.8 wt % of a propoxylated glycerin to a reactor and stripping it to remove residual water. Then, 31.6 wt % phthalic anhydride was added to the propoxylated glycerin to form a half-ester. The half-ester was alkoxylated with 25.4 wt % propylene oxide. PO digestion was completed in the presence of 2.0 wt % N,N-dimethylethanolamine (DMEA). The product was then vacuum stripped to remove unreacted PO and other volatiles. The resultant propoxylated polyester-polyether polyol had a hydroxyl value of from about 295 mg KOH/g to about 330 mg KOH/g as measured by ASTM D4274D and a viscosity of between 20,000 and 40,000 mPa*s at 25° C.

TABLE 1
Compositions

| | | | Compar- | Compar- | Compar- |
|---|---|---|---|---|---|
| | Exam- | Exam- | ative | ative | ative |
| Materials | ple 1 | ple 2 | Example 1 | Example 2 | Example 3 |
| TERCAROL ™ | 39.2 | 0 | 39.2 | 39.2 | 39.2 |
| 8092 | | | | | |
| VORANOL ™ | 0 | 39.2 | 0 | 0 | 0 |
| RN490 | | | | | |
| propoxylated | 39.2 | 39.2 | 0 | 0 | 0 |
| polyester- | | | | | |
| polyether polyol | | | | | |
| #1 | | | | | |
| aromatic | 0 | 0 | 39.2 | 0 | 0 |
| polyester polyol | | | | | |
| # 1 | | | | | |
| TERCAROL ™ | 0 | 0 | 0 | 0 | 39.2 |
| 5902 | | | | | |
| Stepanpol PS | 0 | 0 | 0 | 39.2 | 0 |
| 3152 | | | | | |
| VORANOL ™ | 7 | 7 | 7 | 7 | 7 |
| CP 1055 | | | | | |
| TCPP | 10.4 | 10.4 | 10.4 | 10.4 | 10.4 |
| PMDETA | 0.1 | 0.1 | 0.1 | 0.1 | 0.1 |
| DMCHA | 0.65 | 0.65 | 0.32 | 0.55 | 0.24 |
| TEGOSTAB B | 2 | 2 | 2 | 2 | 2 |
| 8496 | | | | | |
| Water | 1.45 | 1.45 | 1.45 | 1.45 | 1.45 |
| Total | 100 | 100 | 99.67 | 99.9 | 99.59 |
| MIX | 100 | 100 | 100 | 100 | 100 |
| c-pentane | 13.5 | 13.5 | 13.5 | 13.5 | 13.5 |
| VORANATE ™ | 123 | 127 | 123 | 123 | 128 |
| M220 | | | | | |
| Index | 1.26 | 1.26 | 1.26 | 1.26 | 1.22 |

All compositions were prepared according to the components provided in Table 1. The polyol compositions were formed, and blowing agent (i.e., c-pentane) was added to them. The polyol compositions, including additives and blowing agents, were mixed using an air mixer at 2,000 rpm until a homogenous liquid was obtained. The polyol mixture was then loaded into a high pressure machine tank and reacted with the isocyanate component (i.e., VORANATE™ M220) to form a polyurethane foam.

Foam samples were prepared by feeding the composition (at a temperature of from about 20° C. to 22° C.) through a Cannon high pressure machine and injected into a Brett mold (0.1 m×0.35 m×2 m) equipped with a thermal heating system in order to control the temperature of the mold. The foams were poured into a 20 cm×20 cm×20 cm wooden box in an amount to at least reach the mold height at the end of the blowing phase. Reactivity parameters (e.g., gel time) and free rise density (FRD) of were measured. FRD is the density measured from a 100×100×100 mm block, obtained from the center of a free rising foam (at ambient air-pressure). Gel time was measured using an iron stick. Gel time was recorded as the time at which the foam undergoing reaction sticks to the iron stick to form strings when the iron stick is removed from the foam mass. The results of these tests are shown in Table 2 below.

TABLE 2
Reactivity Test and Foam Profile

| | | | | | Comparative | | Comparative | | Comparative | |
|---|---|---|---|---|---|---|---|---|---|---|
| | Example 1 | | Example 2 | | Example 1 | | Example 2 | | Example 3 | |
| Cream/Gel | 17 s/131 s | | 15 s/142 s | | 19 s/155 s | | 15 s/107 s | | 13 s/129 s | |
| Time at 20-22° C. | | | | | | | | | | |
| Free rise | 27.6 | g/L | 28.4 | g/L | 30.8 | g/L | 29.8 | g/L | 28.7 | g/L |
| density | | | | | | | | | | |
| Foamat, 40° C., | 230 | Pa | 150 | Pa | 130 | Pa | 180 | Pa | 150 | Pa |
| 300′ | | | | | | | | | | |
| acquisition | | | | | | | | | | |
| time, pressure | | | | | | | | | | |
| at gel time | | | | | | | | | | |

In various embodiments, such as embodiments in which the foam will be formed using a discontinuous process, a gel time of greater than 120 s is preferred, since faster gel times can render the formulation unsuitable for use in a discontinuous process.

The minimum filling density (MFD) is the minimum weight of material that is needed to fill the Brett mold. This value divided by the mold volume equals the density needed to fill the mold. The flow index is the ratio between MFD and FRD.

The average density deviation (ADD) from seventeen (17) foam specimens formed in the Brett mold was calculated as follows:

$$A D D = {\sum }_{i = 1}^{17} \frac{\vert \overline{d} - {d}_{i} \vert}{17}$$

where 17 is the number of samples, d̅ is the average density, and dᵢ is the density of the i^{th} sample.

The compressive strength for each of the foam samples was measured according to EN 826. The thermal insulation (lambda value) for each of the foam samples was measured according to EN 12667 by means of a guarded hot plate apparatus.

Tensile bond strength was measured according to EN 1607. In particular, two steel specimens measuring 20 cm×30 cm×0.4 mm were fixed onto internal Brett mold surfaces about 120 cm from the injection point. Once the Brett mold was filled with the reacted PU foam, the steel-faced foam was cut and submitted to the tensile bond strength test.

The results of the Brett molded foams tests are presented in Table 3 below.

TABLE 3
Results of the Brett Molded Foams Tests

| | | | | | Comparative | | Comparative | | Comparative | |
|---|---|---|---|---|---|---|---|---|---|---|
| | Example 1 | | Example 2 | | Example 1 | | Example 2 | | Example 3 | |
| MFD | 38.3 | g/L | 39.75 | g/L | 39.5 | g/L | 37.0 | g/L | 42.46 | g/L |
| Flow Index | 1.388 | | 1.400 | | 1.289 | | 1.242 | | 1.479 | |
| Molded | 40.88 | g/L | 42 | g/L | 42.09 | g/L | 41.07 | g/L | 44.4 | g/L |
| Density (5-10% | | | | | | | | | | |
| O.P.) | | | | | | | | | | |
| ADD | 0.34 | | 0.445 | | 0.476 | | 0.639 | | 0.653 | |
| Compressive | 139.2 | kPa | 140.2 | kPa | 105.8 | kPa | 120.3 | kPa | 120.9 | kPa |
| strength, | | | | | | | | | | |
| thickness | | | | | | | | | | |
| Thermal | 20.28 | mW · m°K | 20.33 | mW · m°K | 20.60 | mW · m°K | 20.36 | mW · m°K | 20.02 | mW · m°K |
| conductivity, | | | | | | | | | | |
| Tensile bond | 151 | kPa | 137 | kPa | 81 | kPa | 96 | kPa | 119 | kPa |
| strength | | | | | | | | | | |

As shown in Table 3, Comparative Example 1 and Comparative Example 2 exhibit tensile bond strength values below 100 kPa. In various embodiments, tensile bond strength below 100 kPa, or even below 120 kPa, is unacceptable because it lacks the properties required for industrial use. Additionally, in various embodiments, a minimum fill density of less than about 40 g/L is preferred. Accordingly, Comparative Example 3 may not be suitable for use for various applications, despite its acceptable tensile bond strength.

The post expansion percentage of each of the foams removed from a 40 cm×70 cm×10 cm jumbo mold was measured. The post expansion percentage was calculated according to the following equation:

$$P . E . \% = [ \frac{( maximum foam thickness - mold thickness )}{mold thickness} ] \times 100$$

Post expansion is a measure of how much expansion occurs when the foam is removed from the mold. Any splits that occurred were also noted, and are presented in Table 4.

For each of the foam samples, the skin cure percentage (i.e., surface curing %) was determined for a given cure time of from about 10 minutes to about 20 minutes at a given temperature. The percentage was calculated by measuring the area of the Brett mold without any attached layer of polyurethane foam having a thickness of at least about 0.1 mm. The percentage of this area versus the total mold surface area gives the percentage of surface curing. Areas may be estimated visually or measured using digital images of the mold surfaces and digital image processing software, such as ImageJ. The results of the curing tests are provided in Table 4 below.

TABLE 4
Curing Tests

| | | | Comparative | Comparative | Comparative |
|---|---|---|---|---|---|
| | Example 1 | Example 2 | Example 1 | Example 2 | Example 3 |
| Plate mold, | 100% | 100% | 35% | 100% | 60% |
| 35° C.; D.T. | | | | | |
| 14 min, skin | | | | | |
| cure | | | | | |
| Plate mold, | 25% | 45% | 10% | 30% | 20% |
| 30° C.; D.T. | | | | | |
| 16 min, skin | | | | | |
| cure | | | | | |
| Jumbo mold, | 40.1 g/L | 41.6 g/L | 41.7 g/L | 40.85 g/L | 44.1 g/L |
| 40° C., 5%-10% | | | | | |
| O.P., | | | | | |
| density | | | | | |
| Jumbo mold, | 2.8% | 2.55% | 1.8% (splits) | 2.0% (splits) | 6.1% (splits) |
| D.T. 14 min, | | | | | |
| post exp. 24 h | | | | | |
| Jumbo mold, | 2.1% | 1.56% | 1% | 1.3% (splits) | 4.5% (small |
| D.T. 16 min, | | | | | splits) |
| post exp. 24 h | | | | | |
| Jumbo mold, | 1.2% | 1.03% | n.d. | 0.6% | 3.75% |
| D.T. 20 min, | | | | | |
| post exp. 24 h | | | | | |
| Jumbo mold, | 0% | 0% | 1.9% | n.d. | n.d. |
| D.T. 24 min, | | | | | |
| post exp. 24 h | | | | | |

As shown in Table 4, each of the comparative examples exhibit split during one or more of the curing tests using the jumbo mold. Splitting is undesirable for various applications, as it could be a source of condensation, among other reasons.

Conventionally, manufacturers sacrifice a superior thermal conductivity to obtain other desirable properties. However, as shown in Tables 1-4, foams formed from formulations including propoxylated polyester-polyether polyol exhibit MFD, tensile bond strength, post expansion, gel time, and compressive strength values desired for various applications while also maintaining a superior thermal conductivity. More specifically, various embodiments of formulations including propoxylated polyester-polyether polyol exhibit a compressive strength of at least 130 kPa, a tensile bond strength of at least 130 kPa, a minimum fill density of less than about 40 g/L, and a gel time of at greater than about 120 s at 20-22° C. Some embodiments exhibit a compressive strength of at least 135 kPa and/or a tensile bond strength of at least 135 kPa.

It is further noted that terms like “preferably,” “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A polyurethane foam produced from a formulation comprising:
(A) an isocyanate reacting mixture comprising:
(i) at least 40 wt % based on a weight of the isocyanate reacting mixture of at least one propoxylated polyester-polyether polyol; and
(ii) at least one of propoxylated sucrose polyol or propoxylated sorbitol polyol, the propoxylated sucrose polyol and/or propoxylated sorbitol polyol having a hydroxyl number of from about 300 mg KOH/g to about 600 mg KOH/g;
(B) an isocyanate component having an average functionality of at least 2.5; and
(C) a blowing agent;
wherein the polyurethane foam has a compressive strength of at least 130 kPa, and wherein a stoichiometric index of the isocyanate component to the isocyanate reacting mixture is between about 1.0 and about 1.7.

2. The polyurethane foam according to claim 1, wherein the isocyanate component comprises methylene diphenyl diisocyanate (MDI).

3. The polyurethane foam according to claim 1, wherein the isocyanate component has an average functionality of from about 2.5 to about 3.2.

4. The polyurethane foam according to claim 1, wherein the blowing agent comprises a hydrocarbon.

5. The polyurethane foam according to claim 4, wherein the hydrocarbon comprises a hydrofluoroolefin carbon.

6. The polyurethane foam according to claim 1, wherein the isocyanate reacting mixture comprises at least 40 wt % by weight of the at least one of propoxylated sucrose polyol or propoxylated sorbitol polyol.

7. The polyurethane foam according to claim 1, the isocyanate reacting mixture further comprising least one propoxylated glycerin polyol having a hydroxyl value of from about 50 mg KOH/g to about 500 mg KOH/g.

8. The polyurethane foam according to claim 1, wherein the formulation has a gel time of greater than about 120 seconds at 20-22° C.

9. The polyurethane foam according to claim 1, wherein the at least one propoxylated polyester-polyether polyol has an average functionality of from about 2.7 to about 4.5.

10. The polyurethane foam according to claim 1, wherein the at least one propoxylated polyester-polyether polyol is derived from propoxylated glycerin.
